(19) United States
(12) Patent Application Publication
(10) Pub. No.: US 2024/0078489 A1
(43) Pub. Date: Mar. 7, 2024

(54) INFORMATION PROCESSING APPARATUS AND INFORMATION PROCESSING METHOD

(71) Applicant: TOYOTA JIDOSHA KABUSHIKI KAISHA, Toyota-shi (JP)

(72) Inventor: Kenji KONDO, Tokyo (JP)

(73) Assignee: TOYOTA JIDOSHA KABUSHIKI KAISHA, Toyota-shi (JP)

(21) Appl. No.: 18/454,130

(22) Filed: Aug. 23, 2023

(30) Foreign Application Priority Data
Sep. 1, 2022 (JP) 2022-139523

(51) Int. Cl. G06Q 10/0631

(52) U.S. Cl. CPC G06Q 10/06316

(57) ABSTRACT

An information processing apparatus, comprises a controller configured to execute: determining that a first vehicle that provides a predetermined service begins to start moving in order to be forwarded, based on an operation plan generated for the first vehicle; determining a vehicle site serving as a forwarding destination of the first vehicle, among a plurality of vehicle sites, based on availability information and facility information on the plurality of vehicle sites; and instructing the first vehicle to move to the determined vehicle site.

### CROSS REFERENCE TO THE RELATED APPLICATION

This application claims the benefit of Japanese Patent Application No. 2022-139523, filed on Sep. 1, 2022, which is hereby incorporated by reference herein in its entirety.

### BACKGROUND

### Technical Field

The present disclosure relates to service providing by a vehicle.

### Description of the Related Art

Systems that provide users with services using a plurality of vehicles use a technique for making appropriate operation plans of vehicles.

As to this technique, for example, Japanese Patent Laid-Open No. 2015-138501 discloses a system that predicts the travel distance and power consumption of a vehicle in order to generate a charging plan of an electric vehicle.

### SUMMARY

The present disclosure has an object to efficiently perform vehicle operation.

The present disclosure in its one aspect provides an information processing apparatus, comprising a controller configured to execute: determining that a first vehicle that provides a predetermined service begins to start moving in order to be forwarded, based on an operation plan generated for the first vehicle; determining a vehicle site serving as a forwarding destination of the first vehicle, among a plurality of vehicle sites, based on availability information and facility information on the plurality of vehicle sites; and instructing the first vehicle to move to the determined vehicle site.

The present disclosure in its another aspect provides an information processing method, comprising: a first step of determining that a first vehicle that provides a predetermined service begins to start moving in order to be forwarded, based on an operation plan generated for the first vehicle; a second step of determining a vehicle site serving as a forwarding destination of the first vehicle, among a plurality of vehicle sites, based on availability information and facility information on the plurality of vehicle sites; and a third step of instructing the first vehicle to move to the determined vehicle site.

Another aspect is a program for causing a computer to execute the method described above, or a computer-readable storage medium that non-transitorily stores the program.

According to the present disclosure, the vehicle operation can be efficiently performed.

### BRIEF DESCRIPTION OF THE DRAWINGS

FIG. 1 is a schematic diagram of a vehicle system according to a first embodiment;

FIG. 2 is a diagram illustrating components of a user apparatus;

FIG. 3 illustrates an example of a service request transmitted from the user apparatus;

FIG. 4 is a diagram illustrating components of a control server;

FIGS. 5A to 5C are diagrams for illustrating operation schedules of vehicles;

FIGS. 6A and 6B are diagrams for illustrating operation schedules of vehicles;

FIG. 7 illustrates an example of site data managed by the control server;

FIG. 8 illustrates an example of vehicle data managed by the control server;

FIG. 9 is a diagram illustrating a flow of processes of issuing a command for operation to a vehicle;

FIG. 10 illustrates an example of an operation command generated by the control server;

FIG. 11 is a diagram illustrating a flow of processes of determining a vehicle site;

FIG. 12 is a diagram illustrating components of a vehicle-mounted device;

FIG. 13 is a sequence diagram of processes of instructing the vehicle to operate, based on a service request;

FIG. 14 is a sequence diagram of processes of determining a forwarding destination, based on vehicle data; and

FIG. 15 illustrates an example of site data according to a second embodiment.

### DESCRIPTION OF THE EMBODIMENTS

A transport system that performs passenger transport by an autonomous driving vehicle has been known. In such a system, a server apparatus that manages operation schedules of a plurality of vehicles generates an operation plan, and issues a command for operation to the vehicle, based on a request by a user and on a predetermined operation diagram.

The vehicle that provides the service is required to enter the vehicle site, where tasks, such as charging and cleaning, are executed, as appropriate. Unfortunately, a parking space and the number of facilities (e.g., chargers) provided at the vehicle site are limited. Accordingly, as the number of vehicles in operation increases, a vehicle that cannot enter the vehicle site possibly occurs.

To solve this problem, a server apparatus that manages the operation of vehicles is required to appropriately assign the vehicles vehicle sites serving as parking destinations.

An information processing apparatus according to a first aspect of the present disclosure includes a controller configured to execute: determining that a first vehicle that provides a predetermined service begins to start moving in order to be forwarded, based on an operation plan generated for the first vehicle; determining a vehicle site serving as a forwarding destination of the first vehicle, among a plurality of vehicle sites, based on availability information and facility information on the plurality of vehicle sites; and instructing the first vehicle to move to the determined vehicle site.

The predetermined service can include, for example, a plurality of services, such as a passenger transport service, a package transport service, a package storage service, and a mobile shop service.

The operation plan is an operation schedule of vehicles. For example, the operation plan includes a schedule related to service providing for demanders, and a schedule related to preparation for providing services. Examples of the preparation for providing services can include, for example, forwarding to the vehicle site, vehicle cleaning, and vehicle charging.

The controller determines that the first vehicle is started to be forwarded (for example, determines that timing of starting forwarding is reached), and determines a vehicle site serving as a forwarding destination of the first vehicle among the plurality of vehicle sites. The forwarding described here is forwarding that allows the vehicle to return to the vehicle site.

That is, the vehicle site serving as the forwarding destination is not designated by the operation plan. The controller assigns the vehicle site serving as the forwarding destination of the first vehicle, at timing when the first vehicle starts to be forwarded.

The assignment of the vehicle site can be performed based on availability information and facility information on a plurality of vehicle sites, for example. That is, a vehicle site that allows parking, and has an appropriate facility is determined as the forwarding destination of the first vehicle.

Note that start of forwarding of the first vehicle may be determined based on the operation plan generated by the apparatus itself, or be determined based on data received from the first vehicle in operation according to the operation plan.

If a plurality of vehicles are preliminarily assigned vehicle sites serving as forwarding destinations, a delay in schedule or the like possibly prevents operation conforming to the preliminary assignment. For example, if the schedule of a certain vehicle is delayed, and completion of charging is delayed, the vehicle scheduled to be charged next is possibly prevented from entering the site as scheduled.

On the other hand, the information processing apparatus according to the present disclosure does not preliminarily assign vehicles vehicle sites. Accordingly, a possible delay in operation schedule of the vehicle or the like does not affect the operation schedule for the other vehicles.

Note that the plurality of vehicle sites may be grouped. A plurality of groups may be defined in accordance with the types of tasks executable at the vehicle sites (e.g., charging, cleaning, etc.), for example. In this case, the operation plan may designate only tasks to be executed at each vehicle site. For example, the operation plan only designates “forwarding to a vehicle site capable of charging”, and when the vehicle is started to be forwarded, the information processing apparatus may assign a vehicle site capable of charging.

The plurality of vehicle sites may be assigned priorities in accordance with facilities. For example, if the facility is a charging facility, the priority may be assigned in accordance with the charging capability (output etc.). For example, if the vehicle site also serves as a parking lot, the priority may be assigned based on the distance from a gateway to a parking space, the time required for entrance and departure or the like. Hereinafter, specific embodiments of the present disclosure are described based on the drawings. The hardware configuration, module configuration, functional configuration and the like described in each embodiment are not intended to limit the technical scope of the disclosure only to them unless otherwise described.

### First Embodiment

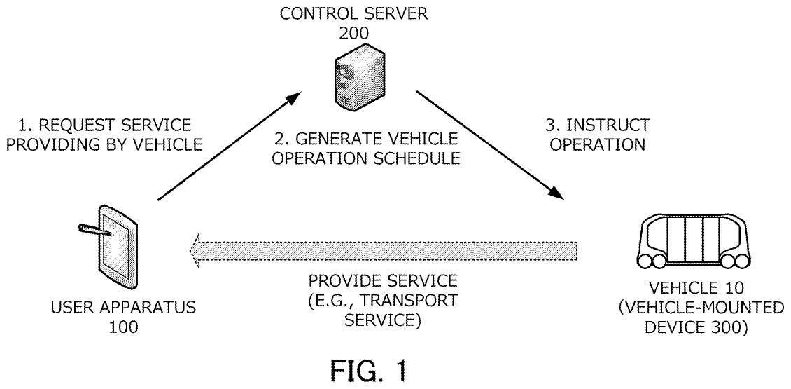

An overview of a vehicle system according to a first embodiment is described with reference to FIG. 1. The vehicle system according to this embodiment is configured to include vehicles 10 each mounted with a vehicle-mounted device 300, user apparatuses 100, and a control server 200. The number of vehicles 10 (vehicle-mounted devices 300) included in the system may be two or more.

The vehicle 10 is an autonomous vehicle that can provide predetermined services for demanders. Examples of the predetermined service include, for example, passenger transport, package transport, package storage, mobile shop providing, working space providing, and sleeping space providing. The vehicle 10 is configured to be capable of wirelessly communicating with the control server 200 via the vehicle-mounted device 300, and is autonomously operated based on an instruction from the control server 200.

A user intending to use the service by the vehicle 10 transmits a service request to the control server 200 via the user apparatus 100. The service request includes, for example, the type of an intended service (e.g., “taxi”), a point and time at which the vehicle 10 is intended to be dispatched, a destination (in a case where the transport service is intended), and a trade name (in a case where the shop service is intended).

For example, these pieces of information can be generated and transmitted by application software that is installed in the user apparatus 100 and is for using the vehicle system. These pieces of information may be generated using a mobile terminal, or generated using any terminal (a smartphone, a mobile phone, a tablet terminal, a personal digital assistant, a wearable computer or the like) or a personal computer that is connectable to a network.

The control server 200 generates an operation schedule of the vehicle 10, based on the service request transmitted from the user apparatus 100. The control server 200 includes a database for managing the operation schedules of a plurality of vehicles 10. When the operation schedule of each vehicle 10 is updated, the control server 200 updates the database. Note that in this Specification, the operation plan, and the operation schedule have the same meaning.

Furthermore, the control server 200 transmits data for commanding each vehicle to operate (hereinafter, an operation command) to the target vehicle 10 (vehicle-mounted device 300), based on the updated operation schedule. The operation command is data for instructing the vehicle 10 to perform a plurality of tasks: for example, “travel to a predetermined point A”, “allow a user to board”, “travel to a predetermined point B”, “allow the user to alight”, and “return to the vehicle site”.

The operation command may include a scheduled time about execution of each task.

The vehicle-mounted device 300 receives the operation command from the control server 200. In a case where the vehicle 10 is an autonomous vehicle, the operation command is transmitted to a device that is mounted on the vehicle 10 and controls autonomous travel. Note that the vehicle 10 may be a crewed vehicle. In this case, the operation command is provided for a crew via the vehicle-mounted device 300.

In the vehicle system according to this embodiment, a plurality of user apparatuses 100, the control server 200, and vehicle-mounted devices 300 are connected to each other via a network. A WAN (Wide Area Network) that is, for example, a world scale public communication network, such as the Internet, or other communication networks may be adopted as the network. The network may also include a telephone communication network, such as mobile phones, and a wireless communication network, such as Wi-Fi (registered trademark).

Each of the elements that constitute the system is described.

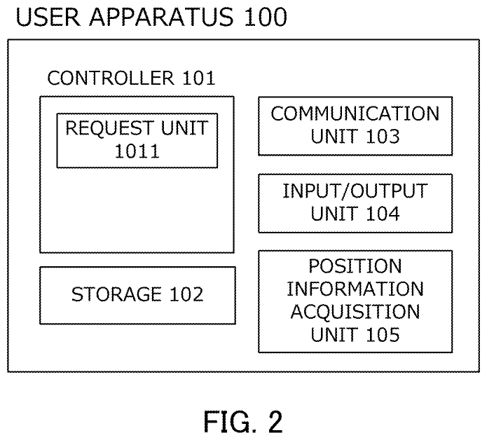

FIG. 2 is a diagram illustrating the system configuration of the user apparatus 100.

The user apparatus 100 is, for example, a small-sized computer, such as a smartphone, a mobile phone, a tablet computer, a personal digital assistant, a notebook computer, or a wearable computer (smart watch etc.). The user apparatus 100 is configured to include a controller 101, a storage 102, a communication unit 103, an input/output unit 104, and a position information acquisition unit 105.

The controller 101 is a computational device that administers control performed by the user apparatus 100. The controller 101 can be achieved by a computation processing device, such as a CPU (Central Processing Unit).

The controller 101 is configured to include a request unit 1011, as a function module. The function module may be achieved by the CPU executing a program stored in the storage 102 described later.

The request unit 1011 acquires, from the user of the apparatus, information required to request the vehicle to provide the service, and transmits the service request including this information to the control server 200.

The service request includes the type of the intended service, and service content. For example, in a case where the intended service is the passenger transport service, an intended boarding point, an intended boarding time, an intended alighting point and the like can be exemplified as the service content. In a case where the intended service is a mobile shop service, the type, identifier, quantity and the like of articles intended to be purchased can be exemplified as the service content. The service content varies depending on the type of the service.

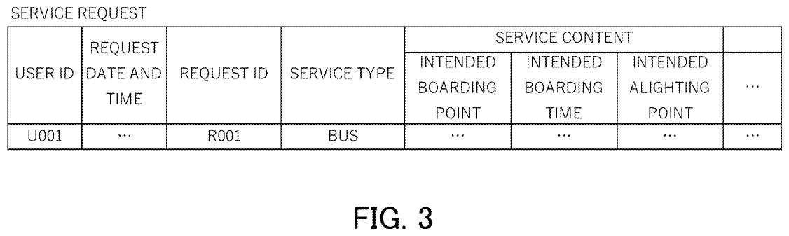

The request unit 1011 acquires these pieces of information via the input/output unit 104 described later. The acquired information is transmitted as the service request to the control server 200. FIG. 3 illustrates an example of the service request generated by the request unit 1011. The request unit 1011 performs a process of confirming a reservation for the vehicle 10, by interaction with the control server 200.

The storage 102 is configured to include a main memory, and an auxiliary storage device. The main memory is a memory where a program to be executed by the controller 101, and data used by the control program are deployed. The auxiliary storage device is a device where a program to be executed by the controller 101, and data used by the control program are stored. The auxiliary storage device may store programs that are to be executed by the controller 101 and are packaged as applications. An operating system for executing the applications may be stored. The programs stored in the auxiliary storage device are loaded into the main memory, and are executed by the controller 101, thus performing processes described later.

The main memory may include a RAM (Random Access Memory), and a ROM (Read Only Memory). The auxiliary storage device may include an EPROM (Erasable Programmable ROM), and a hard disk drive (HDD). Furthermore, the auxiliary storage device may include a removable medium, i.e., a portable recording medium.

The communication unit 103 is a wireless communication interface for connecting the user apparatus 100 to the network. For example, the communication unit 103 provides access to the network, through a wireless LAN, or a mobile communication service, such as 3G, LTE, 4G or 5G.

The input/output unit 104 is a unit that accepts input operation performed by the user of the apparatus, and presents information. In this embodiment, the input/output unit 104 is made up of one touch panel display. That is, the input/output unit 104 is made up of a liquid crystal display and its control unit, and a touch panel and its control unit.

Next, the configuration of the control server 200 is described.

The control server 200 can be configured as a computer that includes a processor, such as a CPU and a GPU, a main memory, such as a RAM and a ROM, and an auxiliary storage device, such as an EPROM, a hard disk drive, or a removable medium. The auxiliary storage device stores the operating system (OS), various programs, various tables and the like. By executing the programs stored there, each function in conformity with a predetermined purpose as described later can be achieved. Note that part of or the entire function may be achieved by a hardware circuit, such as an ASIC or an FPGA. Note that the control server 200 may be made up of a single computer, or made up of a plurality of computers that cooperate with each other.

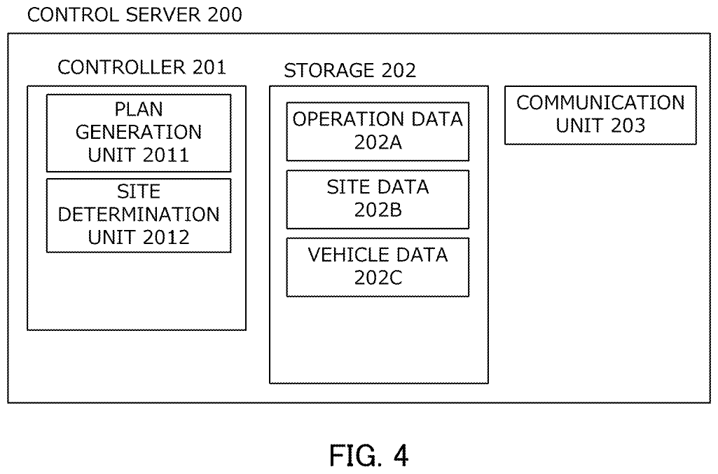

FIG. 4 is a diagram illustrating the system configuration of the control server 200. The control server 200 is configured to include a controller 201, a storage 202, and a communication unit 203.

The controller 201 is a computational device that administers control performed by the control server 200. The controller 201 can be achieved by a computation processing device, such as a CPU.

The controller 201 is configured to include two function modules that are a plan generation unit 2011, and a site determination unit 2012. Each function module may be achieved by the CPU executing a program stored in an auxiliary storage unit.

Firstly, the plan generation unit 2011 updates the data for managing the operation schedule of the vehicles 10, based on the service request received from the user apparatus 100. Secondly, the plan generation unit 2011 transmits the operation command to the vehicle 10, based on the operation schedule.

In this embodiment, operation data is exemplified as the data for managing the operation schedule of the vehicles 10. The operation data is a set of the operation schedules of the plurality of vehicles 10 (described later in description of the storage 202).

Specifically, when the service request is transmitted, the plan generation unit 2011 refers to the operation schedule for each vehicle, determines the vehicle 10 that is to provide the service, and updates the operation schedule of this vehicle. After the operation schedule is determined, the plan generation unit 2011 generates the operation command for operating the vehicle 10 according to the operation schedule, and transmits it to the target vehicle 10.

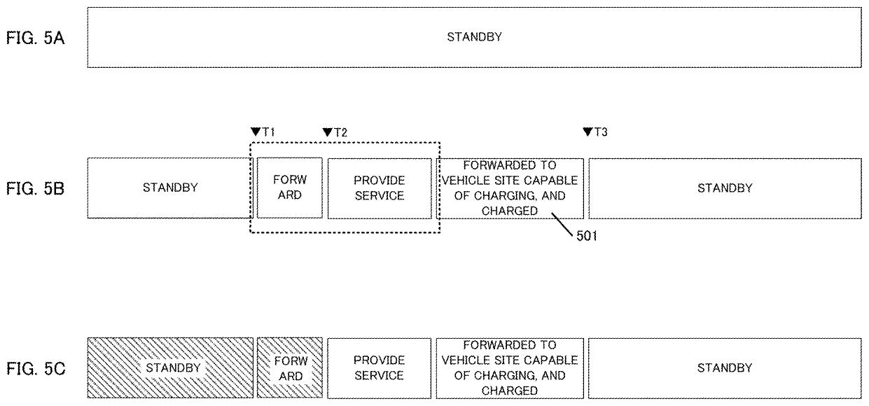

FIGS. 5A to 5C are diagrams illustrating the operation schedule of the vehicle 10.

FIG. 5A is a diagram illustrating a state where no operation schedule is set with respect to the vehicle 10. In this case, the vehicle 10 is in a standby state at a predetermined vehicle site.

FIG. 5B illustrates an example of an operation schedule updated based on a service request for requesting the transport service. The operation schedule includes, for example, a plurality of tasks that include “standby”, “forwarding”, and “service providing”. In this example, the vehicle 10 departs from the vehicle site at time T1, and travels toward a designated point. At time T2, a user is picked up, and the transport service is provided.

After the service providing is finished, the vehicle 10 is forwarded to the vehicle site, and is charged. In this embodiment, the plan generation unit 2011 does not preliminarily identify the vehicle site serving as a forwarding destination, and determines which vehicle site the after-mentioned site determination unit 2012 forwards the vehicle 10 to at the timing of starting the forwarding. That is, until execution of the transport service is completed, as indicated by a symbol 501 on the operation schedule, the state is one where only the time slot and the type of the vehicle site (e.g., “a vehicle site capable of charging”) are designated. Consequently, the vehicle site from which the vehicle 10 departs, and the vehicle site to which the vehicle 10 returns can be different from each other.

The vehicle site serving as the forwarding destination of the vehicle 10 is dynamically determined by the site determination unit 2012, based on the type of the vehicle site, the geographical distance, the parking space situation or the like, for example. Detailed processes of determining the vehicle site serving as the forwarding destination are described later.

When the charging is completed at time T3, the vehicle 10 comes into the standby state again, thus being in a state capable of responding to another request.

In the examples in FIGS. 5A to 5C, “charging” is exemplified as a task executed at the vehicle site as the forwarding destination. Alternatively, the types of tasks to be executed at the vehicle site of the forwarding destination, and the execution order of tasks may be determined based on a predetermined rule. For example, each of the plurality of the tasks may be assigned a priority, and the execution order of the tasks to be executed at the vehicle site may be determined based on the priorities. In the following description, the tasks executed at the vehicle site are called preparation tasks.

Note that the plan generation unit 2011 may reflect achievement in the operation schedule, based on data (hereinafter, vehicle data) received from the vehicle 10 (vehicle-mounted device 300). For example, hatching parts in FIG. 5C represent tasks having already been completed. With respect to a specific vehicle, it can be determined which task has been completed in accordance with the vehicle data received from the vehicle 10 (vehicle-mounted device 300).

The site determination unit 2012 determines that there is a vehicle 10 having finished providing the service (hereinafter, also called operation) and starting to move toward the vehicle site, and determines the vehicle site serving as the forwarding destination of this vehicle.

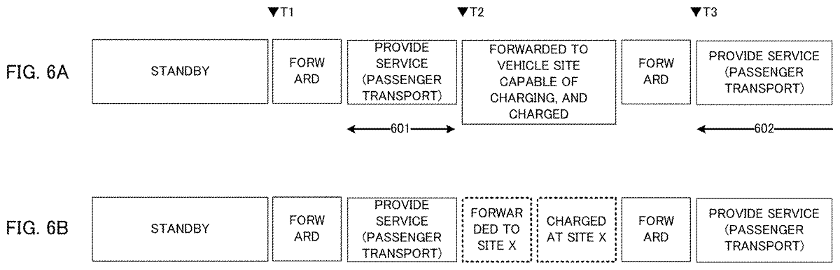

FIG. 6A illustrates an example of the operation schedule generated for a certain vehicle 10. In this example, two operations that are the operation indicated by a symbol 601, and the operation indicated by a symbol 602 are sequentially performed.

As described above, in this embodiment, in a case where the vehicle 10 performs a plurality of operations, it is not preliminarily designated which vehicle site the vehicle 10 is forward to during the operations. If there is any vehicle 10 that starts forwarding after the operation, the site determination unit 2012 assigns the vehicle 10 a vehicle site that satisfies the following condition.
(A) a vehicle site having an available parking space
(B) a vehicle site having a facility for executing a designated preparation task
(C) a vehicle site at a distance allowing start of the next operation in time

In this example, the site determination unit 2012 searches for a vehicle site that can execute a task “charging”, allows parking, and allows arrival at the designated point by time T3, and assigns it as a standby place of the vehicle 10. The assignment can be performed based on data about the availability situation at each vehicle site, and on data defining executable tasks for each vehicle site (described later).

FIG. 6B illustrates an example of an operation schedule after the site determination unit 2012 assigns the vehicle site serving as the forwarding destination of the vehicle 10.

The site determination unit 2012 acquires data about a plurality of vehicle sites (hereinafter, site data), determines the forwarding destination of the vehicle 10 based on this, and corrects the operation schedule.

In this embodiment, the operation command issued by the plan generation unit 2011 does not include designation of the forwarding destination after completion of the operation. The vehicle site serving as the forwarding destination is determined by the site determination unit 2012 at timing when the vehicle 10 finishes the operation, and an instruction is issued to the vehicle 10.

The storage 202 is configured to include a main memory, and an auxiliary storage device. The main memory is a memory where a program to be executed by the controller 201, and data used by the control program are deployed. The auxiliary storage device is a device where a program to be executed by the controller 201, and data used by the control program are stored.

The storage 202 stores operation data 202A, site data 202B, and vehicle data 202C.

The operation data 202A is data for recording the operation schedules of the plurality of vehicles 10. For example, the operation data 202A is data representing the operation schedule of the vehicle 10 in a time-series manner as illustrated in FIGS. 5A to 5C and FIGS. 6A and 6B.

The site data 202B includes data about a plurality of vehicle sites.

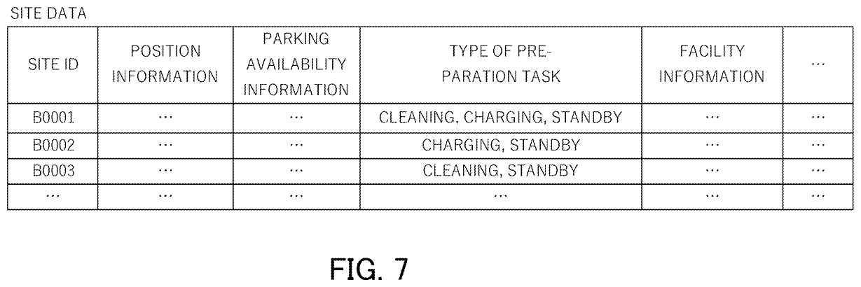

FIG. 7 illustrates an example of the site data 202B. The site data is data that associates the identifiers of the vehicle sites, position information on the vehicle sites, parking availability information (availability information on the parking space), types of executable preparation tasks, and facility information with each other. The facility information is information about details of facilities for executing preparation tasks (e.g., charging facilities).

The site data 202B may be called data acquired by grouping a plurality of vehicle sites according to executable preparation tasks.

With reference to the site data 202B, it can be determined which vehicle site the vehicle 10 is forwarded to in order to execute the predetermined preparation task. Note that the parking availability information may be periodically acquired from an external apparatus that manages availability information on the parking space.

The vehicle data 202C is a set of vehicle data items received from the vehicles 10 (vehicle-mounted devices 300). As described above, the vehicle data is data indicating the current situation of the vehicle 10.

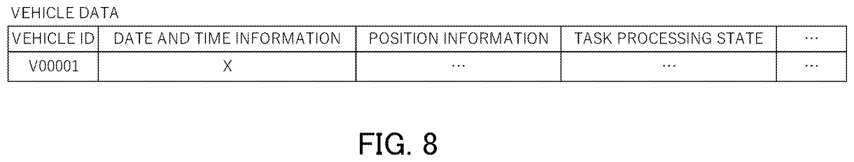

FIG. 8 illustrates an example of the vehicle data. The vehicle data includes an identifier of the vehicle 10, date and time information, position information on the vehicle 10, and the processing state of a task (for example, which task among the plurality of given tasks has been finished, or which is currently in execution). The processing state of the task may include a delay time period from the planned schedule.

The communication unit 203 is a communication interface for connecting the control server 200 to the network. The communication unit 203 is configured to include, for example, a network interface board, and a wireless communication circuit for wireless communication.

Here, the flow of processes executed by the aforementioned plan generation unit 2011 and site determination unit 2012 is described in more detail.

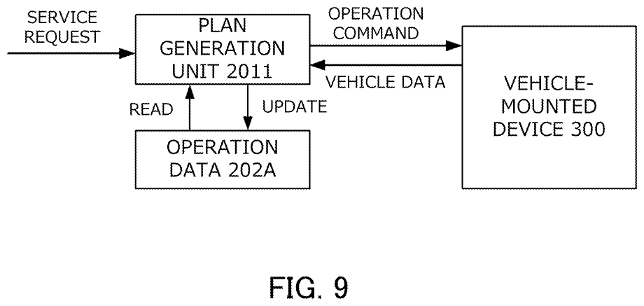

FIG. 9 is a diagram illustrating the flow of processes determining the operation schedule of the vehicle 10, based on the service request, and commanding the vehicle 10 to operate.

The plan generation unit 2011 determines a vehicle 10 that provides the service, based on the service request received from the user apparatus 100. The vehicle 10 that provides the service can be determined based on the operation data 202A. For example, if the requested service is the transport service, the plan generation unit 2011 determines the vehicle 10 that can schedule a series of tasks “traveling to a designated point from the vehicle site, providing the transport service, returning to the vehicle site, and being charged”.

If there is a vehicle 10 that can schedule the series of tasks, the operation schedule illustrated in FIG. 5A is updated as in FIG. 5B. When the operation schedule is determined, the plan generation unit 2011 generates a corresponding operation command, and transmits the operation command to the vehicle-mounted device 300 mounted on the vehicle 10 that is a target.

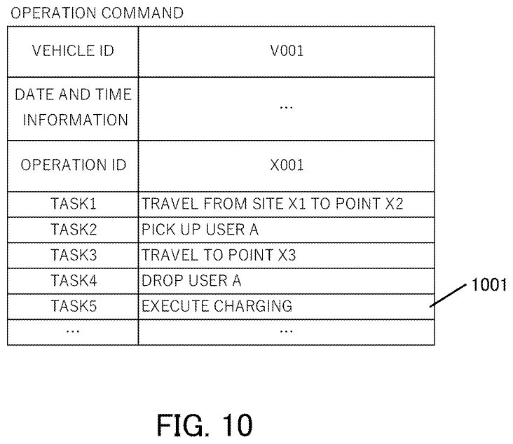

FIG. 10 illustrates an example of the operation command. As illustrated in the diagram, the operation command includes a plurality of tasks to be executed by the vehicle 10. Each task may be associated with a start scheduled time, a finish scheduled time, or a deadline time. As described above, at a stage where the operation schedule is determined, it is not designated which vehicle site the vehicle 10 returns to after completion of the operation (symbol 1001).

Returning to FIG. 9, the description is continued.

The plan generation unit 2011 can periodically receive the vehicle data from each vehicle 10 (vehicle-mounted device 300), and update the operation schedule based on it.

For example, the plan generation unit 2011 may determine that the operation schedule of the vehicle 10 is delayed, based on the vehicle data received from the vehicle 10. The delay from the schedule can be determined based on the task processing state included in the vehicle data, for example. If the operation schedule is delayed, the plan generation unit 2011 may correct or regenerate the operation schedule in order to restore the delay.

If the delay cannot be restored, or if the subsequent schedule is delayed by this, the plan generation unit 2011 may transmit a notification about this to a system administrator or the user apparatus 100.

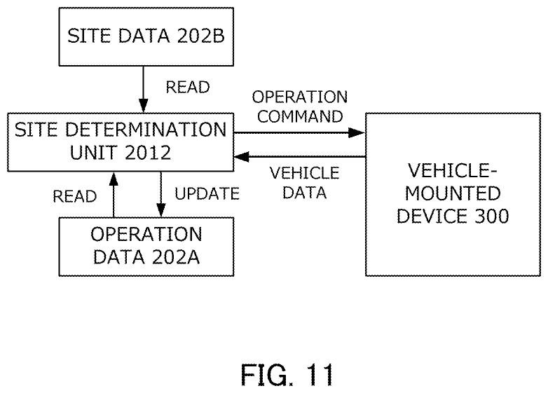

FIG. 11 is a diagram illustrating the flow of processes where the site determination unit 2012 determines the vehicle site serving as the forwarding destination of the vehicle 10, corrects the operation schedule of the vehicle 10, and issues an instruction about the determined vehicle site to the vehicle 10.

The site determination unit 2012 determines that the vehicle 10 has finished the operation (i.e., at timing of starting forwarding), based on the vehicle data received from the vehicle 10.

The site determination unit 2012 refers to the operation data 202A, and the site data 202B, and extracts vehicle sites that satisfy all the following conditions.
(A) the parking space is available
(B) a facility for executing a designated preparation task (e.g., a charging facility) is present
(C) the distance allows start of the next operation in time

Note that to determine the (C) described above, the site determination unit 2012 may calculate a time required for forwarding, and a time required for the preparation task. The time required for the preparation task can be calculated based on the current amount of charge, the target amount of charge, the cleaning state and the like of the vehicle 10, for example.

Note that if there are a plurality of designated preparation tasks (e.g., charging, cleaning, etc.), a vehicle site capable of executing all of them is to be extracted.

After the vehicle site serving as the forwarding destination is determined, the site determination unit 2012 updates the operation data 202A, based on the determination, and transmits an operation command for instructing forwarding, to the vehicle 10. The operation command includes the identifier of the vehicle site serving as the forwarding destination.

If the assignment of the vehicle site serving as the forwarding destination is impossible, the site determination unit 2012 may transmit a notification about this to the administrator or the like of the system.

Next, the configuration of the vehicle-mounted device 300 is described.

The vehicle-mounted device 300 is a computer mounted on the vehicle 10. The vehicle-mounted device 300 exchanges information about the operation by communicating with the control server 200.

The vehicle-mounted device 300 may also serve as a device that provides information for the crew or passengers of the vehicle 10. The vehicle-mounted device 300 may be an electronic control unit (ECU) that a vehicle platform has. The vehicle-mounted device 300 may be a data communication module (DCM) having a communication function.

The vehicle-mounted device 300 has a function of wirelessly communicating with an external network. The vehicle-mounted device 300 may have a function of downloading traffic information, road map data and the like by communicating with the external network.

The vehicle-mounted device 300 can be configured as a computer that includes a processor, such as a CPU and a GPU, a main memory, such as a RAM and a ROM, and an auxiliary storage device, such as an EPROM, a hard disk drive, or a removable medium. The auxiliary storage device stores the operating system (OS), various programs, various tables and the like. By executing the programs stored there, each function in conformity with a predetermined purpose as described later can be achieved. Note that part of or the entire function may be achieved by a hardware circuit, such as an ASIC or an FPGA.

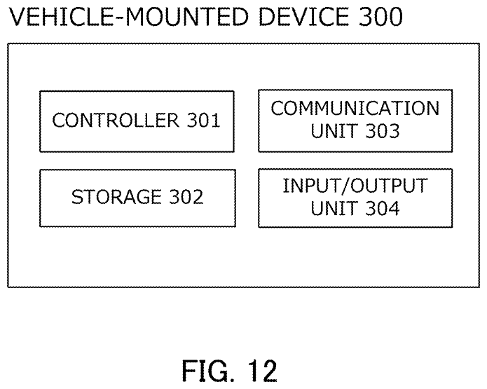

FIG. 12 is a diagram illustrating the components of the vehicle-mounted device 300 in detail.

The vehicle-mounted device 300 is configured to include a controller 301, a storage 302, a communication unit 303, and an input/output unit 304.

The controller 301 is a computational unit that achieves various functions of the vehicle-mounted device 300 by executing predetermined programs. The controller 301 may be achieved by a CPU or the like, for example. The controller 301 may achieve its function by the CPU executing stored programs.

The controller 301 acquires or generates data (vehicle data) about the operation of the vehicle 10 at predetermined timing, and transmits it to the control server 200. The vehicle data includes, for example, position information, and the task processing state. The controller 301 has a function of acquiring the position information via a GPS module or the like.

The storage 302 is a unit that stores information, and is made up of a storage medium, such as a RAM, a magnetic disk, or a flash memory. The storage 302 stores various programs to be executed by the controller 301, and data and the like used by the programs.

The communication unit 303 includes an antenna and a communication module for wireless communication. The antenna is an antenna element that performs input and output of wireless signals. In this embodiment, the antenna conforms to mobile communication (e.g., mobile communication of 3G, LTE, 5G or the like). Note that the antenna may be configured to include a plurality of physical antennas. For example, in a case of mobile communication using radio waves in a high-frequency band, such as microwaves, or millimeter waves, the plurality of antennas may be arranged in a distributed manner in order to facilitate communication stabilization. The communication module is a module for performing mobile communication.

The input/output unit 304 is a unit that accepts input operation, and presents information. In this embodiment, the input/output unit 304 is made up of one touch panel display. That is, the input/output unit 304 is made up of a liquid crystal display and its control unit, and a touch panel and its control unit.

Note that the configurations illustrated in FIGS. 2, 4, and 12 are examples. The entire or part of illustrated function may be achieved using a circuit designed in a dedicated manner. The programs may be stored or executed by a combination of the main memory and the auxiliary storage device that is other than what is illustrated.

Next, the processes executed by each apparatus are described.

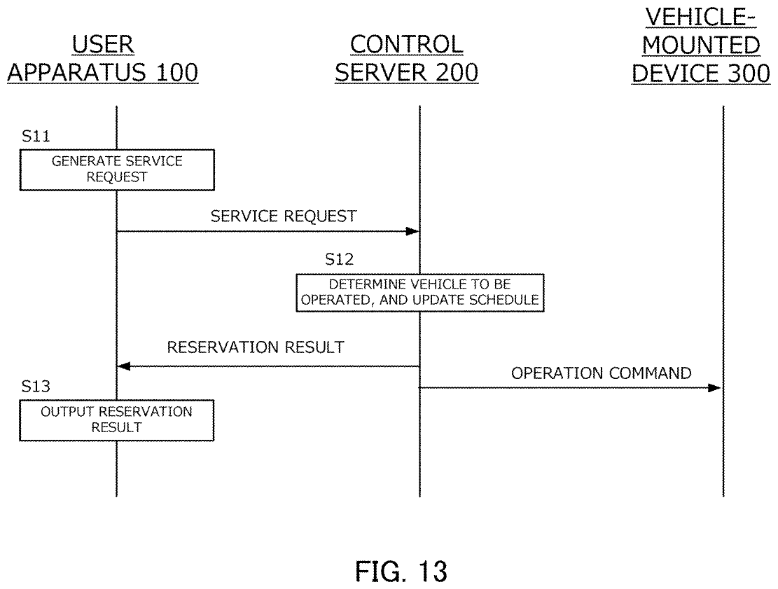

FIG. 13 is a sequence diagram of processes by the control server 200 accepting the service request. The illustrated processes are started based on operation by the user.

First, in step S11, the user apparatus 100 (request unit 1011) generates the service request. In this step, the user is allowed to input the service to be requested, and data about its content, through a predetermined interface.

The service request includes the type of the intended service, and service content. For example, in a case where the intended service is the passenger transport service, an intended boarding point, an intended boarding time, an intended alighting point and the like can be exemplified as the service content. In a case where the intended service is a mobile shop service, the type, identifier, quantity and the like of articles intended to be purchased can be exemplified as the service content.

The request unit 1011 transmits the generated service request to the control server 200 (plan generation unit 2011).

In step S12, the control server 200 (plan generation unit 2011) determines the vehicle 10 that provides the service, based on the operation data 202A, and generates its operation schedule. The vehicle 10 that provides the service can be determined based on a time period required to provide the requested service, and on the attribute and the like of the vehicle 10. When the operation schedule is determined, the plan generation unit 2011 generates a corresponding operation command, and transmits the operation command to the vehicle-mounted device 300 mounted on the vehicle 10 that is a target. The plan generation unit 2011 transmits a reservation result to the user apparatus 100, and the request unit 1011 outputs it (step S13). Accordingly, the user can confirm that the reservation for the vehicle 10 is established.

The vehicle-mounted device 300 transmits the operation command to a device that controls autonomous travel, or provides it for the crew. Accordingly, the operation of the vehicle 10 is started.

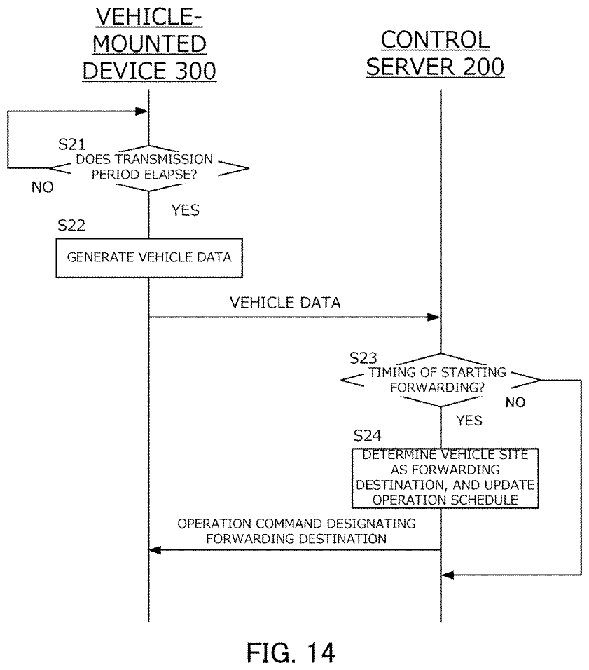

FIG. 14 is a sequence diagram of a process by the vehicle-mounted device 300 and the control server 200 transmitting and receiving the vehicle data. The illustrated process is repeatedly executed by the controller 301 at a predetermined period during operation of the vehicle 10.

Note that in this example, it is assumed that the vehicle-mounted device 300 transmits the vehicle data at a predetermined period. Alternatively, transmission of the vehicle data may be performed only at timing of occurrence of a predetermined event. For example, timing when the vehicle 10 starts a new task, timing when the task in execution is completed by the vehicle 10, or timing when the vehicle 10 reaches a predetermined spot can be exemplified as such timing.

First, in step S21, the vehicle-mounted device 300 determines whether a predetermined transmission period elapses or not. If the predetermined period (e.g., every one minute) elapses, the processing transitions to step S22. If the predetermined period does not elapse, a predetermined time is waited for, and the process is repeated.

In step S22, the vehicle-mounted device 300 generates the vehicle data. The generated vehicle data is transmitted to the control server 200.

In step S23, the control server 200 (plan generation unit 2011) determines that it is the timing when the vehicle 10 starts forwarding, based on the vehicle data transmitted from the vehicle-mounted device 300. Note that forwarding includes forwarding for returning to the vehicle site after completion of the operation, and forwarding toward a designated point from the vehicle site in order to perform the operation. Here, the former is concerned. When the timing of the vehicle 10 starting forwarding arrives, the processing transitions to step S24.

In step S24, the site determination unit 2012 refers to the operation data 202A, and determines the preparation task to be executed by the vehicle 10. In this step, the facility (e.g., the charging facility) that the vehicle site as the forwarding destination should include is determined based on the preparation task (e.g., charging) to be executed by the vehicle 10. A vehicle site that has the facility, and allows parking is selected. The selection of the vehicle site can be performed based on the conditions (A) to (C) described above.

When the vehicle site serving as the forwarding destination is selected, the site determination unit 2012 updates the operation schedule of the vehicle 10 in order to forward the vehicle 10 to the selected vehicle site. An operation command for the vehicle 10 is generated, and is transmitted to the vehicle 10 (vehicle-mounted device 300). The operation command includes data designating the determined vehicle site.

Note that the control server 200 may execute, besides the processes illustrated in FIG. 14, a process of correcting the operation schedule of the vehicle 10 (e.g., a process of restoring the delay by changing the time periods of the preparation tasks in case the schedule is delayed), based on the received vehicle data.

As described above, in the vehicle system according to the first embodiment, the control server 200 determines the vehicle site serving as the forwarding destination, at the timing when the vehicle 10 starts forwarding. If a plurality of vehicles are preliminarily assigned vehicle sites serving as forwarding destinations, a delay in schedule or the like possibly prevents operation conforming to the preliminary assignment. However, according to this embodiment, the vehicle site can be appropriately assigned in accordance with situations.

### Second Embodiment

In the first embodiment, the control server 200 determines the vehicle site serving as the forwarding destination of the first vehicle, in accordance with the facility that the vehicle site has. For example, in the case where the vehicle 10 is required to be charged, the forwarding destination of the vehicle 10 is determined from the group of the vehicle sites that have charging facilities.

On the other hand, if there are vehicle sites that can execute the same preparation task, the facilities sometimes are different from each other. For example, in the case of executing the preparation task that is charging, a vehicle site capable of quick charging is available in some cases, and a vehicle site capable of normal charging is available in the other cases. Charging schemes can include a plug-in scheme that requires manual operation, and a non-contact scheme that allows unmanned charging.

The second embodiment is an embodiment where a plurality of vehicle sites are assigned priorities in accordance with such facilities that the vehicle sites have, and a vehicle site serving as a forwarding destination is determined based on the priority.

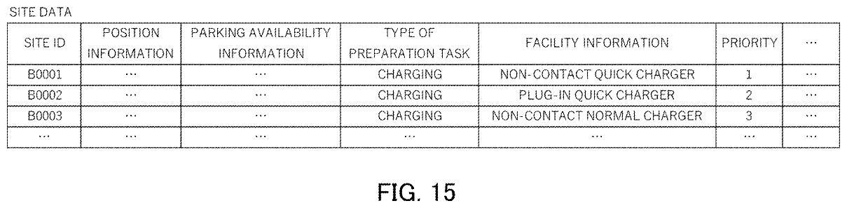

FIG. 15 illustrates an example of the site data 202B stored in the storage 202 according to the second embodiment. In the second embodiment, the site data 202B is associated with information about the facilities and the priority that each vehicle site has. In this example, the type of a charger is exemplified as the information about the facilities. In this example, a value in accordance with the type of the facility is exemplified as the priority. Here, a vehicle site that has a non-contact quick charger is assigned the highest priority.

In the second embodiment, if a plurality of vehicle sites are selectable in step S24, the vehicle site serving as the forwarding destination is selected based further on the priority. For example, a vehicle site having the highest priority is selected from among the available vehicle sites. According to such a configuration, the vehicle site that is most preferred for the vehicle 10 can be selected.

Note that it can vary which vehicle site is preferred as the forwarding destination, depending on the attribute of the vehicle 10. For example, if the vehicle 10 is an uncrewed vehicle, and is required to be charged, a vehicle site that has a non-contact charger capable of uncrewed charging is preferred. On the other hand, if the vehicle 10 is a crewed vehicle, a vehicle site having a plug-in charger may be selected. If the operation schedule of the vehicle 10 is not so tight, normal charging is sometimes more preferred than quick charging. Consequently, in accordance with the attribute and situations of the vehicle 10, the priority may be dynamically changed. That is, the definition of the priority is not necessarily what is fixed as illustrated in FIG. 15. The attribute and situations of the vehicle 10 include, for example, the capability of autonomous travel, current amount of charge, target amount of charge, degree of delay from the schedule, time to the next scheduled item, and the relative position to the vehicle site.

In this example, the charging facility is exemplified as a facility that the vehicle site has. Alternatively, the facility that the vehicle site has may be other than this.

For example, the types of parking lots at vehicle sites can include a flat type, a multistory type, and a mechanical type. Preferably, for example, the vehicle 10 having insufficient spare time to the next scheduled item is preferentially assigned a vehicle site having a flat type parking space that requires less time for entrance and departure. The vehicle 10 having sufficient spare time to the next scheduled item may be assigned a vehicle site having a mechanical parking space. Thus, the priority may be assigned in accordance with the type of the parking lot at the vehicle site.

If a plurality of vehicle sites having the same priority are selectable, a vehicle site as a forwarding destination may be determined based on the distance and the required time. For example, the vehicle site closest to the vehicle 10, the vehicle site reachable in the shortest time, or the vehicle site having the shortest travel distance to the start of the next operation can be selected.

### Modification Example

The embodiments described above are only examples. The present disclosure can be appropriately changed and implemented in a scope without departing from the gist.

For example, the processes and units described in this disclosure can be freely combined and implemented unless any technical contradiction occurs.

The description of the embodiment thus includes the example of on-demand operation of the vehicle 10 in response to the request by the demander. Alternatively, the operation schedule and the operation path of the vehicle 10 may be preliminarily defined.

In the description of the embodiments, the timing when the vehicle 10 starts forwarding is determined based on the data (vehicle data) received from the vehicle 10. Alternatively, the timing when the vehicle 10 starts forwarding may be determined based on data other than this. For example, the control server 200 may determine that the timing when a certain vehicle 10 finishes the operation is reached, based on the operation schedule recorded in the operation data 202A. The control server 200 may determine that a user gets out from the vehicle 10 (i.e., the operation of the vehicle 10 is finished), based on data received from a terminal held by the user.

Processing described as being performed by one apparatus may be shared and executed by a plurality of apparatuses. Or alternatively, processing described as being performed by different apparatuses may be executed by one apparatus. In a computer system, what hardware configuration (server configuration) each function is realized by can be flexibly changed.

The present disclosure can be realized by supplying a computer program implemented with the functions described in the above embodiments to a computer, and one or more processors that the computer has reading out and executing the program. Such a computer program may be provided for the computer by a non-transitory computer-readable storage medium connectable to a system bus of the computer or may be provided for the computer via a network. As the non-transitory computer-readable storage medium, for example, a disk of a given type such as a magnetic disk (a floppy (R) disk, a hard disk drive (HDD) and the like) and an optical disc (a CD-ROM, a DVD disc, a Blu-ray disc and the like), a read-only memory (ROM), a random-access memory (RAM), an EPROM, an EEPROM, a magnetic card, a flash memory, an optical card, and a medium of a given type that is appropriate for storing electronic commands are included.

What is claimed is:

1. An information processing apparatus, comprising a controller configured to execute:
determining that a first vehicle that provides a predetermined service begins to start moving in order to be forwarded, based on an operation plan generated for the first vehicle;
determining a vehicle site serving as a forwarding destination of the first vehicle, among a plurality of vehicle sites, based on availability information and facility information on the plurality of vehicle sites; and
instructing the first vehicle to move to the determined vehicle site.

2. The information processing apparatus according to claim 1, wherein
the plurality of vehicle sites each belong to any of a plurality of groups,
the operation plan includes information designating a group corresponding to the forwarding destination of the first vehicle; and
the controller determines the vehicle site serving as the forwarding destination of the first vehicle, among the vehicle sites belonging to the designated group.

3. The information processing apparatus according to claim 2, wherein
the plurality of groups are defined in accordance with types of tasks executable at the vehicle site, and
the operation plan includes designation of the task to be executed at the vehicle site.

4. The information processing apparatus according to claim 1, wherein
the operation plan is shared with the first vehicle, and does not include information designating the vehicle site serving as the forwarding destination of the first vehicle.

5. The information processing apparatus according to claim 1, wherein
the plurality of vehicle sites are assigned priorities in accordance with facilities, and
the controller determines the vehicle site serving as the forwarding destination of the first vehicle, based on the priorities.

6. The information processing apparatus according to claim 5, wherein
the controller selects the vehicle site that has an available parking lot, and the facility having a highest priority, as a forwarding destination of the first vehicle, from among the plurality of vehicle sites.

7. The information processing apparatus according to claim 5, wherein
the plurality of vehicle sites are vehicle sites that have charging facilities, and
the priorities are defined in accordance with charging capabilities of the charging facilities.

8. The information processing apparatus according to claim 5, wherein
the plurality of vehicle sites are vehicle sites that have charging facilities, and
the priorities are defined in accordance with types of the charging facilities.

9. The information processing apparatus according to claim 6, wherein
the priorities are defined in accordance with a type of the parking lot.

10. The information processing apparatus according to claim 6, wherein
if there are a plurality of vehicle sites whose priorities are identical to each other,
the controller determines the vehicle site serving as the forwarding destination of the first vehicle, based on a distance from the first vehicle.

11. An information processing method, comprising:
a first step of determining that a first vehicle that provides a predetermined service begins to start moving in order to be forwarded, based on an operation plan generated for the first vehicle;
a second step of determining a vehicle site serving as a forwarding destination of the first vehicle, among a plurality of vehicle sites, based on availability information and facility information on the plurality of vehicle sites; and
a third step of instructing the first vehicle to move to the determined vehicle site.

12. The information processing method according to claim 11, wherein
the plurality of vehicle sites each belong to any of a plurality of groups,
the operation plan includes information designating a group corresponding to the forwarding destination of the first vehicle; and
the second step determines the vehicle site serving as the forwarding destination of the first vehicle, among the vehicle sites belonging to the designated group.

13. The information processing method according to claim 12, wherein
the plurality of groups are defined in accordance with types of tasks executable at the vehicle site, and
the operation plan includes designation of the task to be executed at the vehicle site.

14. The information processing method according to claim 11, wherein
the operation plan is shared with the first vehicle, and does not include information designating the vehicle site serving as the forwarding destination of the first vehicle.

15. The information processing method according to claim 11, wherein
the plurality of vehicle sites are assigned priorities in accordance with facilities, and
the vehicle site serving as the forwarding destination of the first vehicle is determined based on the priorities.

16. The information processing method according to claim 15, wherein
the second step selects the vehicle site that has an available parking lot, and the facility having a highest priority, as a forwarding destination of the first vehicle, from among the plurality of vehicle sites.

17. The information processing method according to claim 15, wherein
the plurality of vehicle sites are vehicle sites that have charging facilities, and
the priorities are defined in accordance with charging capabilities of the charging facilities.

18. The information processing method according to claim 15, wherein
the plurality of vehicle sites are vehicle sites that have charging facilities, and
the priorities are defined in accordance with types of the charging facilities.

19. The information processing method according to claim 16, wherein
the priorities are defined in accordance with a type of the parking lot.

20. The information processing method according to claim 15, wherein
if there are a plurality of vehicle sites whose priorities are identical to each other,
the second step determines the vehicle site serving as the forwarding destination of the first vehicle, based on a distance from the first vehicle.
